(19) United States
(12) Patent Application Publication
(10) Pub. No.: US 2007/0005483 A1
(43) Pub. Date: Jan. 4, 2007

(54) Technique for providing a personalized auction service through an information assistance provider

(76) Inventor: Andrew P. Graham, Beaverton, OR (US)

Correspondence Address: JONATHAN TYLER;c/o Kaye Scholer LLP, 425 Park Avenue, New York, NY, 10022, US

(21) Appl. No.: 11/262,604

(22) Filed: Oct. 31, 2005

Related U.S. Application Data
(63) Continuation-in-part of application No. 11/170,310, filed on Jun. 29, 2005.

(51) Int. Cl. G06Q 40/00

(52) U.S. Cl. 705/37

(57) ABSTRACT

To provide a personalized auction service, data pertaining to one or more of a user's accounts with different online auction service providers (OASPs), such as URLs of the OASPs and account access data, is maintained in a folder by an information assistance service, which is unaffiliated with the OASPs. When the user calls the information assistance service, the user's folder is retrieved. The user's OASP accounts may be accessed on behalf of the user based on the URLs of the OASPs and account access data in the user's folder. An information assistance provider including, for example, an operator and/or a voice server, may perform on behalf of the user one or more operations with respect to one or more of the user's OASP accounts, including initiating an auction, for example.

### RELATED APPLICATIONS

The present application is a continuation-in-part of U.S. application Ser. No. 11/170,310, filed on Jun. 29, 2005, which is assigned to the assignee of the present invention and is incorporated by reference herein.

### FIELD OF THE INVENTION

The invention relates to a communications system and method, and more particularly to a system and method for enabling a user of an information assistance service to access and use an online auction service.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications, such as wireless telephones, is ubiquitous.

Wireless phones conveniently allow users while traveling to call and communicate with other people. In case a user cannot remember the telephone number of a contact or it is not handy, or the user wants to obtain directions and other information concerning, e.g., restaurants, theaters, etc., he/she can call an information assistance provider for assistance which includes, e.g., an operator, a voice server, etc. To that end, an expansive network of communication call centers has been established which provides users with nationwide assistance.

With the advent of Internet technology, Internet-based marketplaces for the sale of goods and services have been developed by companies like eBay Inc., Yahoo! Inc., etc. These companies typically offer a website through which buyers and sellers browse, buy and sell, in the form of an auction, various items including trading cards, antiques, dolls, housewares, used cars, clothing, books, electronics, etc. For example, the eBay auction service permits sellers to list items for sale, buyers to bid on items of interest, and all users to browse through listed items online. It also offers online payment services to facilitate consummation of transactions.

An online auction service typically requires a user to register with the service and establish an account. The user may subsequently access the account by providing his/her user ID and password. If a user wishes to initiate an auction to sell one or more objects via an online auction account, the user typically must enter various pieces of information pertaining to the object(s) to be sold. Such information typically includes a title of the auction, a description of the object to be sold, a minimum bid, duration of the auction, etc.

### SUMMARY OF THE INVENTION

The invention is premised upon the recognition that accessing an auction account associated with an online auction service provider (OASP) may currently be inconvenient for some users. For example, a user who is traveling by car and has access to a wireless telephone but no access to a computer with an Internet connection may not be able to access an online auction account. In such circumstances, a user cannot easily perform operations concerning the online auction account, such as initiating an auction, for example.

The invention enables an information assistance provider to assist a user to access the user's online auction account and initiate an auction via the account. In accordance with an embodiment of the invention, data concerning access to one or more auction accounts associated with a user is stored and may be maintained by the inventive service. When a subsequent communication from the user is received by the information assistance provider through a first communications connection, the data is retrieved and used to access the one or more auction accounts over a second communications connection. One or more operations with respect to an auction are performed through the second communication connection on behalf of the user.

For example, a method is provided to enable a communications system, such as an information assistance provider, to initiate an auction based on a caller's request. In one embodiment, the method comprises: receiving via a wireless communications device a request to initiate an auction with an online auction service unaffiliated with the system, and initiating the auction with the online auction service, based on the request. Upon making the request, the user may identify to the operator an auction account that the user maintains with the online auction service.

In accordance with an embodiment of the invention, a user file containing access data pertaining to the user's auction account(s) is generated and stored. For example, the user file may include a URL, a user name and a password for one or more online auction accounts. When a request is received from a user to access an auction account, the user file is accessed and the access data stored therein is used to access the user's auction account(s). Accordingly, the method described above may further comprise: accessing a data file associated with the user, retrieving from the data file data concerning access to the auction account, and accessing the auction account over the second communications connection, based on the data.

The user may be prompted to provide information required by a respective OASP in order to initiate the auction. The information is received from the user and provided to the OASP. Thus, the method described above may also comprise: determining one or more data items required by an auction service provider associated with the auction account, receiving from the user information pertaining to the one or more data items, and transmitting the information to the auction service provider. The information may include a title of an auction, a minimum bid value, a duration of an auction, a description of an auction, a number of items to be offered in an auction, a minimum bid increment value, etc.

Additionally, an image of an object offered for sale in an auction may be posted in a location accessible to potential bidders in an auction. Accordingly, the information assistance provider may receive from the user at least one image of one or more objects offered in the auction, and post a digital version of the image at a location on a network that is accessible to persons bidding in the auction. The image may be posted at a URL accessible via the Internet, for example.

In accordance with another embodiment of the invention, a method is provided to enable a first party, such as an information assistance provider, to initiate an auction. The method comprises receiving a request to initiate an auction, and accessing an auction account maintained by a second party not affiliated with the first party, in accordance with the request. The second party may comprise an OASP, for example. The request may be received through a first communication connection, such as a telephonic connection, and the auction account may be accessed through a second communication connection, such as an Internet connection. The method further comprises initiating an auction with the second party via the auction account in accordance with the request. The first party may verify the user's identity before initiating the auction.

In yet another embodiment of the invention, a system is provided to enable a first party, such as an information assistance provider, to initiate an auction. The system comprises: an interface configured to receive via a wireless communications device a request to initiate an auction with an online auction service unaffiliated with the system, and a processor configured to initiate the auction with the online auction service, based on the request.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system including information/call centers, in accordance with the invention;

FIGS. 2A and 2B are block diagrams of components of the communications system of FIG. 1;

FIG. 3 is a block diagram of a personalized online auction service (POAS) gateway in the communications system of FIG. 1;

FIG. 4 is a flowchart depicting a routine for eliciting from a user information for establishing the POAS, in accordance with the invention;

FIG. 5 illustrates a record maintained in a user's POAS folder, in accordance with the invention;

FIG. 6 illustrates a Login graphical user interface (GUI) for providing the POAS, in accordance with the invention;

FIG. 7 is a flowchart depicting a routine for obtaining information concerning a user's accounts with different online auction service providers, in accordance with the invention;

FIG. 8 illustrating a Listing GUI containing any bidding and tracking lists of auction items, in accordance with the invention;

FIG. 9 illustrates an Auction Status GUI containing information concerning an auction of an item selected from a bidding list, in accordance with the invention;

FIG. 10 is a flowchart depicting an example of a routine for initiating an online auction in accordance with a caller's request, in accordance with the invention;

FIG. 11 is an example of a GUI that displays items of information required to initiate an online auction, in accordance with the invention; and

FIG. 12 is a flowchart depicting an example of a routine for making an image of an object available for viewing by prospective bidders, in accordance with the invention.

### DETAILED DESCRIPTION

The invention is directed to providing personalized information and communications services to users, such as telephone and mobile device users. One of these services is a personalized online auction service (POAS) in accordance with the invention, which allows a user to, among others, access the user's online auction account and to initiate an auction via the auction account. In accordance with an embodiment of the invention, data concerning access to one or more auction accounts associated with a user is stored and may be maintained by the inventive service. When a communication from the user is received by an information assistance provider through a first communications connection, the data is retrieved and used to access the one or more auction accounts over a second communications connection. One or more operations with respect to an auction are performed through the second communication connection on behalf of the user.

For example, in accordance with an embodiment of the invention the information assistance provider may access a user's auction account(s) and initiate an auction in accordance with a user's request. Accordingly, the information assistance provider receives a telephone call from a user and a request to access one or more of the user's online auction accounts. The information service provider may also receive a request to initiate an auction via a specified account. In response to the user's request, the information assistance provider accesses the specified auction account and initiates an auction. The information assistance provider may additionally prompt the user to provide information required by the respective OASP associated with the specified auction account, in order to initiate the auction. Upon receiving the information from the user, the information assistance provider provides the information to the OASP.

The inventive POAS enables a user to communicate with (by calling, for example) an information assistance provider to access one or more online auction accounts maintained by different online auction service providers (OASPs) with which the user has registered and established an account. These OASPs are unaffiliated with the information assistance provider. The user's OASP account information, such as logins (user IDs and passwords) for different OASPs, may be maintained by the information assistance provider in a “POAS folder” associated with the user.

To facilitate tailoring the information assistance service to individuals' needs, one or more folders are maintained for a user, based on which the service is rendered to the user. For example, as disclosed in copending, commonly assigned U.S. application Ser. No. 09/865,230, filed on May 25, 2001, incorporated herein by reference, contacts folders and appointment folders may be created and maintained to store a user's contacts and appointments information, respectively. In addition, in accordance with an aspect of the invention, a POAS folder may be created and maintained to store a user's online auction service information, e.g., data pertaining to one or more OASP accounts that the user wishes to access via the information assistance service. Such accounts were previously established by the user with such OASPs as eBay Inc., Yahoo! Inc., etc., which are unaffiliated with the present information assistance service provider. With the POAS folder in place, when the user accesses, e.g., by calling, the information assistance service, the user may request the information assistance provider (e.g., an operator or a voice server) to perform one or more operations with respect to the user's auction accounts, include, for example, initiating an auction.

Like a contacts or appointments folder, a POAS folder for a user may be maintained by the information assistance service in association with an identifier of the user, e.g., the user's telephone number. Thus, in this particular illustrative embodiment, when an information assistance call is received, the subject service locates the folders associated with the caller based on an automatic number identification (ANI) associated with the call. As is well known, the ANI identifies the telephone number of the communications device from which the call originates. However, it should be noted that a user identification (ID), password, PIN, mother's maiden name, user voiceprint, etc. may be used in combination with, or in lieu of, an ANI to identify a user. For example, use of a voiceprint to identify a user is disclosed in copending, commonly assigned U.S. application Ser. No. 10/403,207 filed on Mar. 31, 2003, incorporated herein by reference.

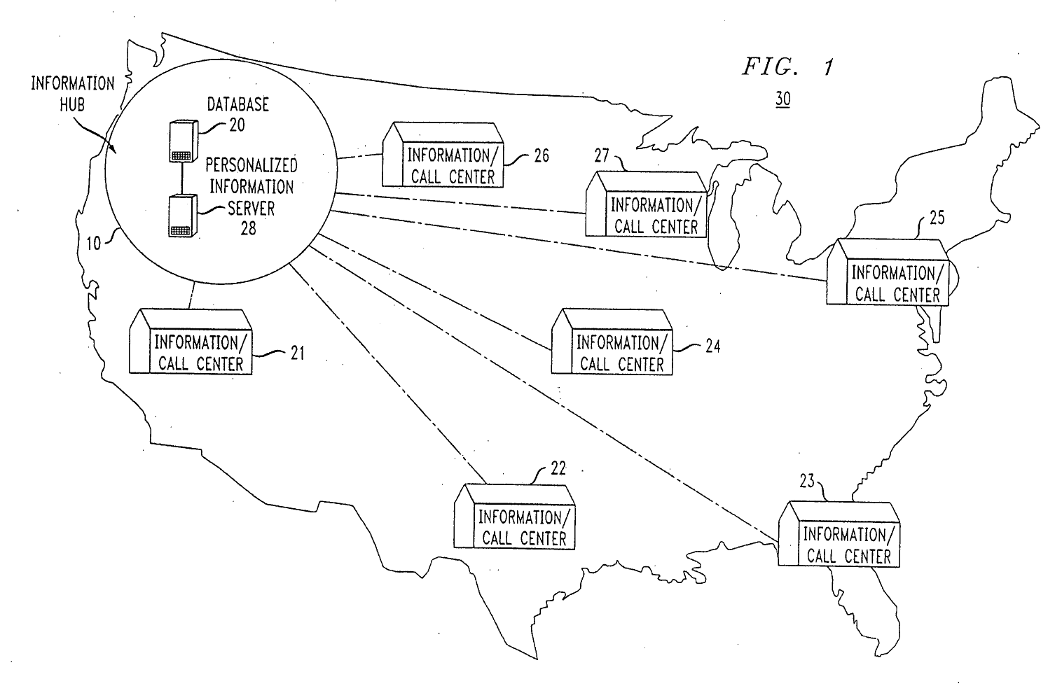

FIG. 1 illustrates a communications system for providing, inter alia, a personalized voice email service in accordance with the invention. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. It should be noted that the term “operators” used herein broadly encompasses entities that are capable of providing assistance in a telecommunications environment, including without limitation human operators, voice response/recognition capabilities, web-/WAP-enabled operator services, and other automated and electronic access. One or more information hubs 10 are also included in WAN 30. An information hub 10 includes one or more personalized information servers 28 which are accessible by the operators in the system, and one or more databases 20 in which users' email, contacts, appointments and other folders may be stored and maintained. Such folders may also be stored locally at one or more of the information/call centers. The folders and information at different centers are synchronized. Synchronized databases provide necessary backup as well as support to roaming mobile device users.

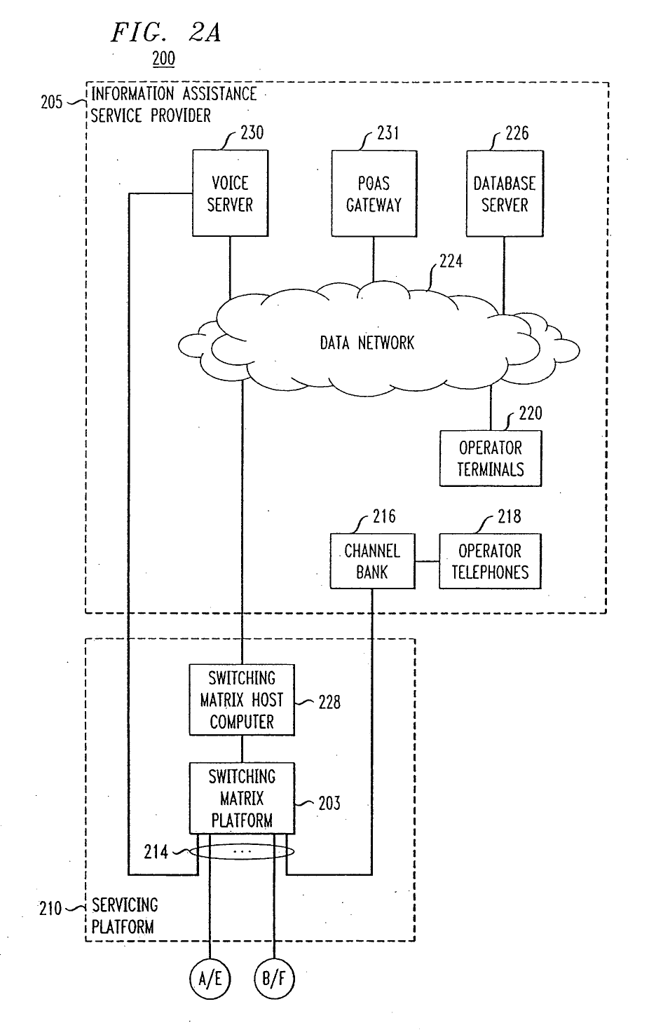

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, POAS gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

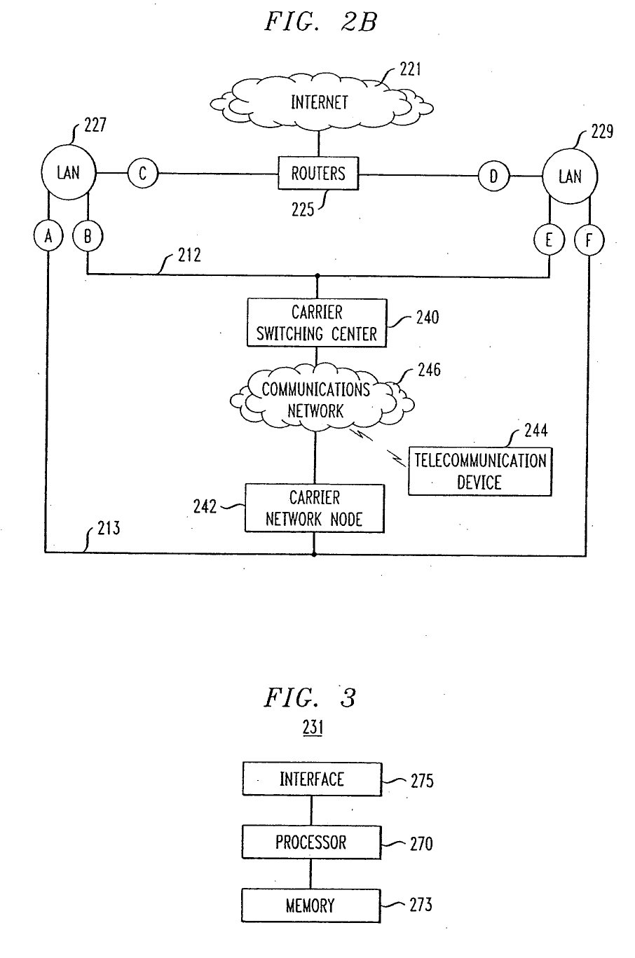

FIG. 3 illustrates POAS gateway 231, which includes processor 270, memory 273 and interface 275. Instructed by software stored in memory 273, processor 270 is configured for communicating with online auction servers operated by various OASPs through interface 275 in accordance with a well known protocol(s) including, e.g., transmission control protocol/Internet protocol (TCP/IP). Interface 275 provides processor 270 with access to data network 224 and thence to Internet 221. For example, in response to signals from terminal 220, processor 270 may initiate Internet access and communicate with the online auction servers operated by such OASPs as eBay, Inc., Yahoo!, Inc., etc. Processor 270 transmits user logins (e.g., user IDs and passwords) from the user's POAS folder to the various online auction servers to log in to the user's accounts. In response, the servers provide any information including, e.g., a tracking list and bidding list of items, associated with the user accounts to gateway 231, which may then selectively transmit the received information to terminal 220 for presentation to a human operator who in turn conveys the same to the user, or to voice server 230 which communicates the same to the user in automated voice.

Users of a particular telephone carrier may dial, speak or otherwise communicate predetermined access digits, access codes or retail numbers, or input a predetermined address or a Uniform Resource Locator (URL) established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

To subscribe to the POAS, the user may call an operator at the designated access number. As part of the registration, the operator enters at a user data web page on server 28 user identifying information including username, password, and telephone number of the particular telecommunications device, e.g., a wireless telephone in this instance, which the user would use to call the information assistance service in the future. It is particularly advantageous to use such a phone number (also known as a mobile directory number (MDN) in the case of a wireless phone number) to identify the user since, as described before, the calling number would be automatically captured as an ANI at information/call center 200 when the user calls. Specifically, platform 214 in center 200 in a well-known manner derives the ANI from the call set-up signals associated with the user's call.

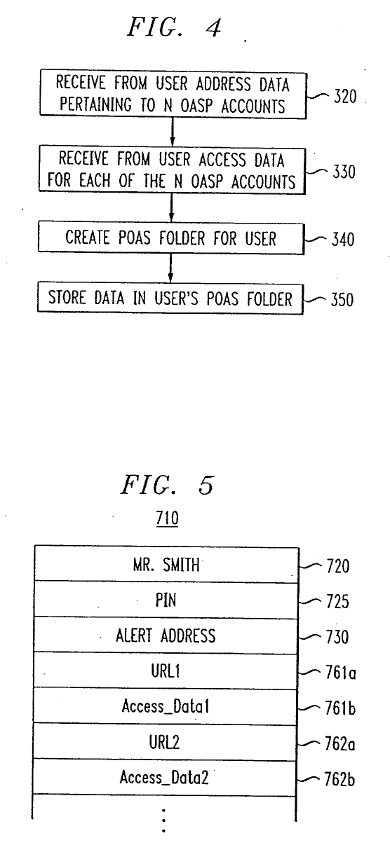

During the registration, the operator may also ask the user which online auction service accounts of his/hers are to be associated with the POAS. The user responds by identifying, say, N, OASP accounts, where N is an integer greater than or equal to one. Thus, as part of the registration, address data pertaining to the user's N OASP accounts is received from the user, as indicated at step 320 in FIG. 4. For example, the user may provide the uniform resource locators (URLs) of the online auction services, e.g., ebay.com, yahoo.com, etc., of which the user is a registered member. It may be necessary to prompt the user to provide sufficiently detailed information to enable POAS gateway 231 to access the specified online auction service accounts. For example, at step 330, the operator elicits and receives from the user access data for each of the N OASP accounts. Access data may include login information, e.g., a user ID, password, etc., associated with each online auction service account. At step 340, a POAS folder is created for the user in database 20. As mentioned before, such a POAS folder may be stored in databases 20, in association with the user's identification data (such as an ANI) for the user's access to his/her online auction service accounts. At step 350, the user's name (and other identifying information, if any), the URLs of the OASPs, and the online auction service account access data are stored in a record in the user's POAS folder.

FIG. 5 illustrates one such record 710 that may be maintained in an POAS folder of a hypothetical user named Mr. Smith. Record 710 comprises fields 720, 725, 730, 761a-b, 762a-b and 763a-b. In this example, field 720 contains Mr. Smith's name. Field 725 contains a personal identification number (PIN) or other identifying information selected by the user for verification of the user's identity when the user instructs an information assistance provider to place a bid in an auction on behalf of the user. Fields 761a and 761b respectively contain the URL (URL1) of Mr. Smith's first OASP and access data (Access_Data1) therefor provided by Mr. Smith. Fields 762a and 762b respectively contain the URL (URL2) of Mr. Smith's second OASP and access data (Access_Data2) therefor provided by Mr. Smith. It should be noted that although in this example, data for two OASP accounts is maintained in record 710, in alternative embodiments data for any number of OASP accounts may be maintained.

It should be noted that in an alternative embodiment, the information assistance provider may maintain one or more accounts with an OASP. In such case, it would not be necessary for a user to provide information concerning auction service accounts upon registration. To subscribe to the POAS, the user may establish a PIN or other identifying information; when the user subsequently calls to initiate an auction or check on the status of an auction, etc., the information assistance provider utilizes its own OASP account to service the user's requests. The operator may also ask the user if he/she wishes to specify an alert address(es), e.g., email address, SMS address, telephone number, etc., to which alerts are to be sent to the user at critical points of an auction. If the user specifies an alert address(es), such an address(es) is registered in field 730 of record 710.

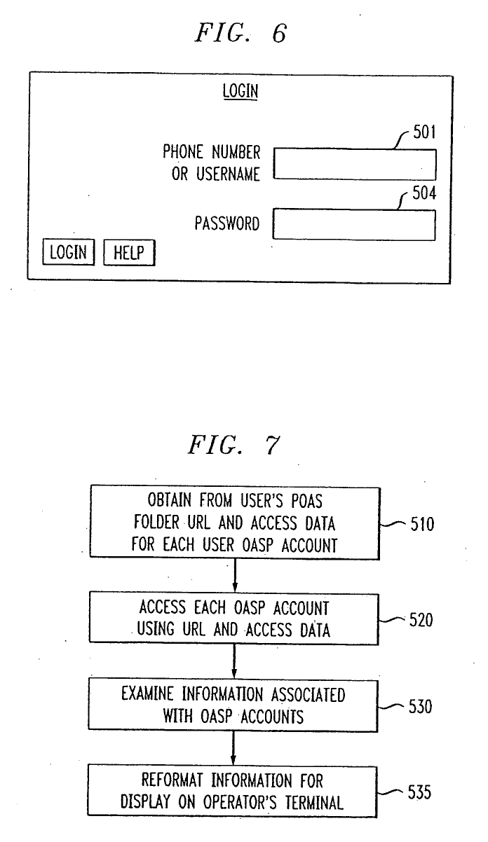

The user may subsequently use telecommunications device 244, e.g., a wireless phone, to call the information assistance service. Let's say the call is routed to information assistance/call center 200 where an operator attends to the call. After the user communicates his/her needs, e.g., to access the POAS, the operator at terminal 220 establishes communications with personalized information server 208 through WAN 30 (or alternatively Internet 221). In response, server 28 presents on terminal 220 a Login graphical user interface (GUI), which is illustrated in FIG. 6. As shown in FIG. 6, the operator is prompted to enter the user's phone number or username to identify the user, and a password to verify that the user is authorized to access the information assistance service. The ANI received from his/her communication device may be automatically provided in entry 501 of the Login GUI by server 28, thereby obviating the need of the operator's eliciting from the user, and entering, the required phone number or username. (In the event that such an ANI is not automatically available, or where the user is accessing the subject service from an unknown point or the operator suspects that the user calls from a phone number other than the registered phone number, the operator may verify/obtain the necessary identifying information with/from the user.) At entry 504, the operator enters the password provided by the user to complete the login process. The login information is then transmitted to server 28, where it checks the aforementioned user data web page to verify the received ANI and password. After they are verified, server 28 identifies the user's POAS folder based on the ANI. A copy of the user's POAS folder is provided to POAS gateway 231.

Let's suppose that Mr. Smith calls the information assistance service, and after his authorization is established, he asks the operator to tell him the status of each online auction in which he has been participating and/or tracking. The operator may select a predetermined option on the screen of terminal 220, and in response, gateway 231 uses the information in Mr. Smith's POAS folder, and in particular record 710 therein, to access his online auction service accounts. FIG. 7 is a flowchart depicting a routine for providing information pertaining to a user's OASP accounts, in accordance with one embodiment. At step 510, gateway 231 obtains from the POAS folder the URL and the access data listed therein for each user OASP account. In the illustrative example, gateway 231 examines, for example, fields 761 and 762 of record 710 and retrieves therefrom the URLs and access data for Mr. Smith's accounts with the respective OASPs. At step 520, gateway 231 accesses each of the OASP accounts using the URL and access data. Gateway 231 may communicate, via Internet 221, with the corresponding online auction servers at their respective URLs pursuant to a standard protocol.

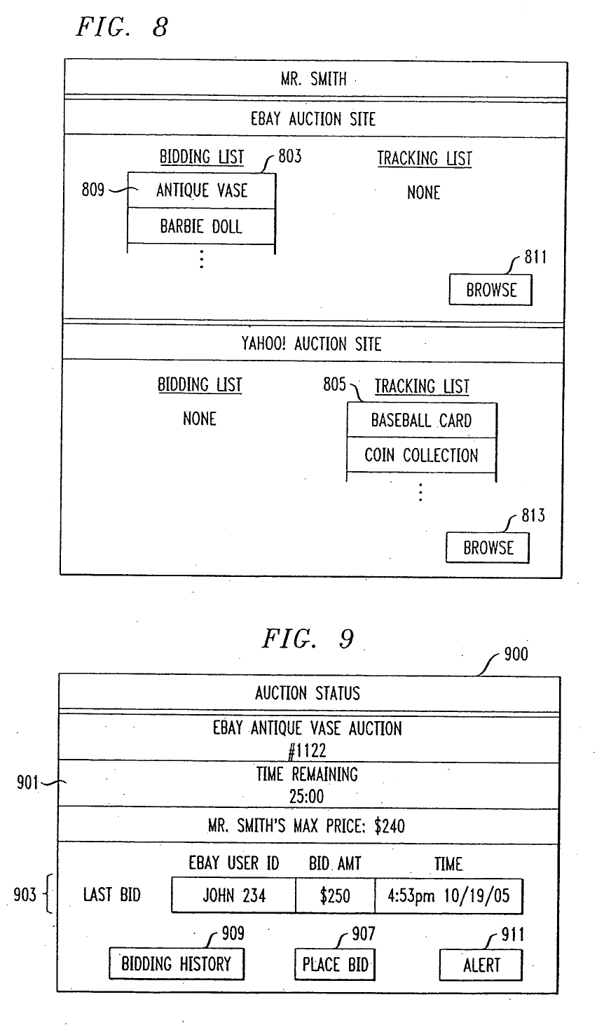

After accessing Mr. Smith's OASP accounts at URL1 and URL2, gateway 231 examines information associated with the OASP accounts which is received from the respective OASPs, as indicated at step 530. Gateway 231 at step 535 reformats the received information for display on operator terminal 220. FIG. 8 illustrates a Listing GUI for presentation on terminal 220, which in this instance includes bidding list 803 associated with Mr. Smith's account with eBay, and tracking list 805 associated with Mr. Smith's account with Yahoo!. For example, bidding list 803 includes items, e.g., an antique vase, a Barbie doll, etc., whose auctions are progressing at the eBay website in which Mr. Smith has been participating. Tracking list 805 includes items, e.g., a baseball card, a coin collection, etc. whose auctions are progressing at the Yahoo! website. Although Mr. Smith may be interested in acquiring the items on list 805, he has not participated in the auctions thereof. The Listing GUI also provides Browse options 811 and 813 for searching, on behalf of Mr. Smith, the respective websites for other items for auctions. Upon request by Mr. Smith, the operator may track, initiate or place a bid in an auction for any item desired by Mr. Smith. Any item for whose auction is tracked would be included in a tracking list, e.g., tracking list 805 for items from the Yahoo! auction site. Any item for which Mr. Smith participates in its auction would be included in a bidding list, e.g., bidding list 803 for items from the eBay auction site.

Continuing the example, Mr. Smith in this instance inquires about the status of the auction of the antique vase on bidding list 803. In response, the operator at terminal 220 selects (e.g., points and clicks at) antique vase item 809 on the list. Gateway 231 causes terminal 220 to show thereon an Auction Status GUI, denoted 900 in FIG. 9. As shown in FIG. 9, Auction Status GUI 900 identifies the antique vase auction in question, i.e., “eBay Antique Vase Auction #1122.” It also shows Time Remaining Indicator 901 for indicating the amount of time remaining in the auction, e.g., 25 minutes and 0 second. In this instance, Mr. Smith chose to bid for the antique vase by way of automatic bidding, where the maximum bidding price for the vase was previously specified by Mr. Smith, e.g., $240. In this example, GUI 900 includes Last Bid entry 903, indicating that the latest bid was submitted by a bidder by the eBay user ID of “John234” at 4:53 pm on 10/9/xx, whose amount is $250. The operator communicates the information in entry 903 to Mr. Smith.

It should be noted at this point that Mr. Smith's eBay user ID is not “John234.” Otherwise, gateway 231 would have translated it to “Mr. Smith” by matching the received eBay user ID from the eBay server with Mr. Smith's eBay user ID in entry 761b and by cross-referencing entry 720 of POAS record 710. It should also be noted that Time Remaining indicator 901 automatically keeps and counts down the remaining time initially received from the eBay server. By comparing Mr. Smith's maximum bidding price, i.e., $240 with the latest bid amount, i.e., $250, gateway 231 realizes that Mr. Smith has been overbid, and causes Place Bid option 907 to be highlighted, prompting the operator to elicit a higher bid from Mr. Smith. In an alternative embodiment, option 907 is highlighted when the competing bid is within a predetermined percentage of, but lower than, Mr. Smith's maximum price.

If Mr. Smith wants to place a higher bid or increase his maximum bidding price, the operator may select option 907 and submits the same information on behalf of Mr. Smith to the eBay server through gateway 231. In accordance with an aspect of the invention, the operator is authorized to place a bid for Mr. Smith only when Mr. Smith can produce the same PIN or other identifying information as that in field 725 of record 710. In addition, the POAS may keep a log of transactions in which Mr. Smith's identity is verified before a bid is placed for him.

Mr. Smith may want to learn the bidding history of the auction in question before he places a new bid. In that case, the operator may select Bidding History option 909 to retrieve from gateway 231 the last K bid entries, which may be shown on GUI 900 in a format similar to that of Last Bid Entry 903, where K represents a predetermined integer.

In accordance with another aspect of the invention, Mr. Smith may ask the operator to send him an alert from time to time which may contain the last bid amount in the auction in question. In that case, the operator may select alert option 911. Selection of option 911 enables the operator to further select one or more of the alert addresses specified in field 730 of record 710, to which one such alert is to be sent. The operator may further select for Mr. Smith the frequency of the alert, which may vary with the time remaining in the auction. For example, within 10 minutes of the closing of the auction, the alert frequency may be once every minute; and within 5 minutes of the closing thereof, the alert frequency may increase to once every 30 seconds. After receiving one such alert at his specified email address, SMS address and/or telephone number, Mr. Smith may want to contact the POAS to further participate the auction through an information assistance provider.

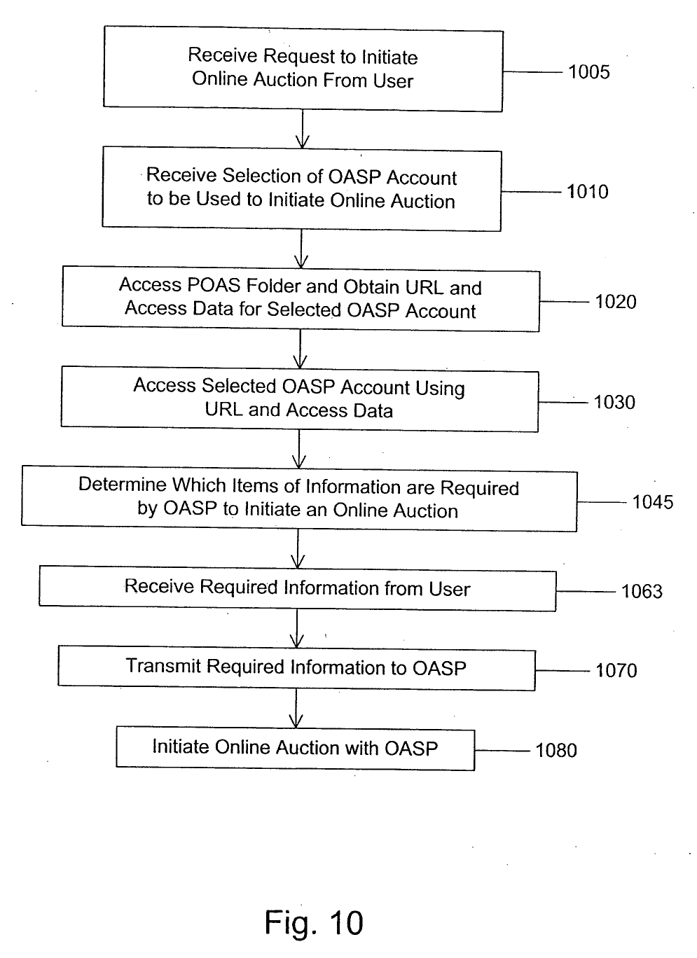

In accordance with yet another aspect of the invention, the operator may initiate an online auction in accordance with a user's request. FIG. 10 is a flowchart depicting an example of a routine for initiating an online auction in accordance with a caller's request, in accordance with an embodiment of the invention. A request to initiate an auction is received from a user, at step 1005. Suppose, for example, that Mr. Smith wishes to initiate an auction to sell a collection of Elvis Presley albums. Suppose further that he prefers to conduct the auction using his OASP account at URL1 (specified in field 761a of record 710). Accordingly, Mr. Smith may call the information assistance service and ask the operator to initiate an online auction on his behalf through his account at URL1.

After Mr. Smith provides the information necessary to establish his authorization, the operator initiates the requested online auction via terminal 220. In this example, the operator may select a button indicating “Online Auction” on the screen of terminal 220, causing an appropriate routine residing in gateway 231 to be invoked. Gateway 231 causes Mr. Smith's various OASP accounts to be displayed on terminal 220 and prompts the operator to indicate which OASP account is to be used to initiate the auction. Because Mr. Smith had previously indicated to the operator that he wished to conduct the auction using his account at URL1, the operator selects Mr. Smith's account at URL1. At step 1020, gateway 231 accesses the POAS folder and obtains the URL and access data for the selected account. Accordingly, gateway 231 examines fields 761a and 761b of record 710 and retrieves therefrom the URL data and access data pertaining to Mr. Smith's OASP account at URL1. At step 1030, gateway 231 accesses the selected OASP account using the retrieved URL and access data. To access the selected OASP account, gateway 231 may communicate via Internet 221 with one or more online auction servers at URL 1 pursuant to a standard protocol.

At step 1045, gateway 231 determines which items of information are required by the respective OASP to initiate and conduct an online auction. Depending on the OASP selected by the user, these required items of information may include, for example: title of the auction, minimum bid, duration of the auction, description of the object to be offered for sale, number of objects for sale, whether or not the auction is closed, whether or not the auction is private or open to select bidders, whether or not it is a Dutch auction, minimum bid increment, etc. Gateway 231 may determine which items of information are required by examining the respective OASP's web site. Alternatively, these items may be known by gateway 231 already. For example, gateway 231 may access a database containing respective records each of which is associated with a popular OASP and lists the items of information required by the respective OASP to initiate an auction.

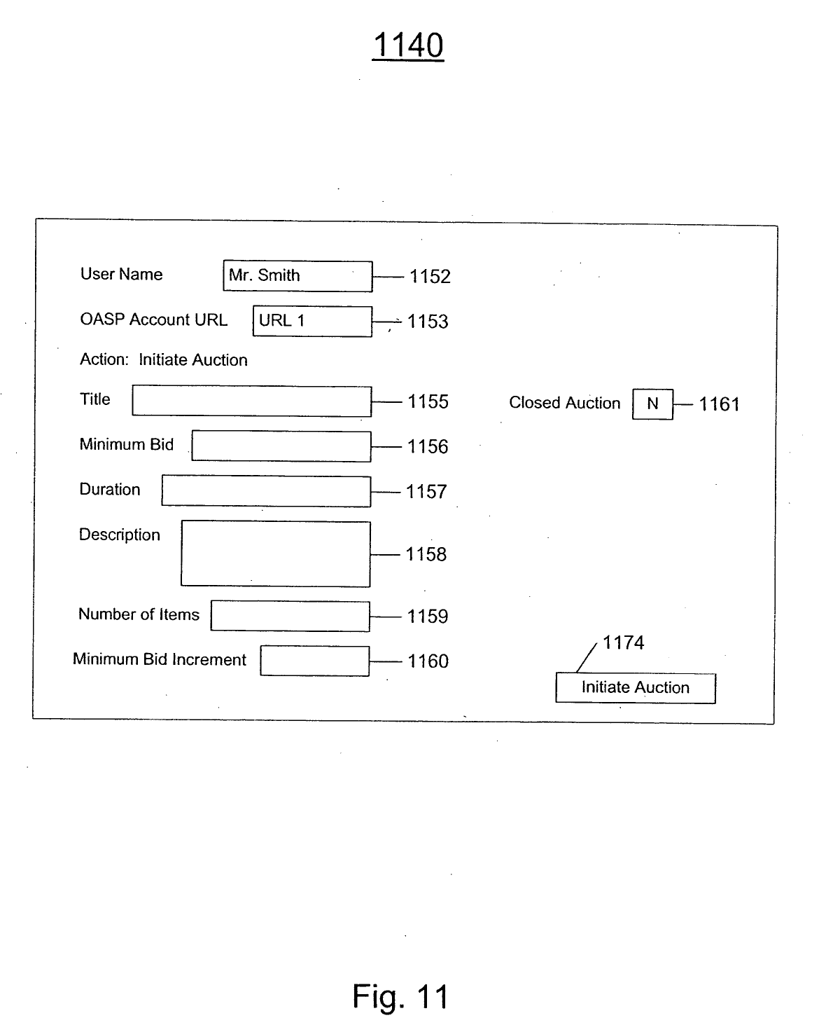

In this example, gateway 231 examines the web pages associated with URL1 to identify the items of information required by the respective OASP. Gateway 231 generates and presents on terminal 220 a GUI for the purpose of obtaining the required information. FIG. 11 is an example of a GUI 1140 that may be displayed on terminal 220 in order to obtain information required to initiate an online auction at URL1, in accordance with an embodiment of the invention. It should be understood that GUI 1140 is an illustrative example only, and that any GUI actually presented to the operator on terminal 220 may differ depending on the requirements of the OASP selected by the user. Referring to FIG. 11, GUI 1140 displays Mr. Smith's name in user name field 1152, and the URL that he previously specified in OASP Account URL field 1153. The information displayed in fields 1152-1153 may be completed automatically by gateway 231. The remaining fields 1155-1161 are completed by the operator. Thus, in this example, the operator may ask Mr. Smith to provide information concerning the title of the auction, the minimum bid, the duration of the auction, a description of the object to be offered for sale, the number of objects to be offered, the minimum bid increment, and whether or not the auction is to be a closed auction. As the operator receives the required information from the user (step 1063), the operator enters the information into fields 1155-1161. The operator then selects the “Initiate Auction” button 1174 by clicking on the displayed icon, for example.

Gateway 231 transmits the information from fields 1155-1161 to the OASP at URL1 in an appropriate manner (step 1070). For example, gateway 231 may communicate via Internet 221 with one or more online auction servers at URL1 pursuant to a standard protocol. At step 1080, gateway 231 directs the OASP to commence the online auction.

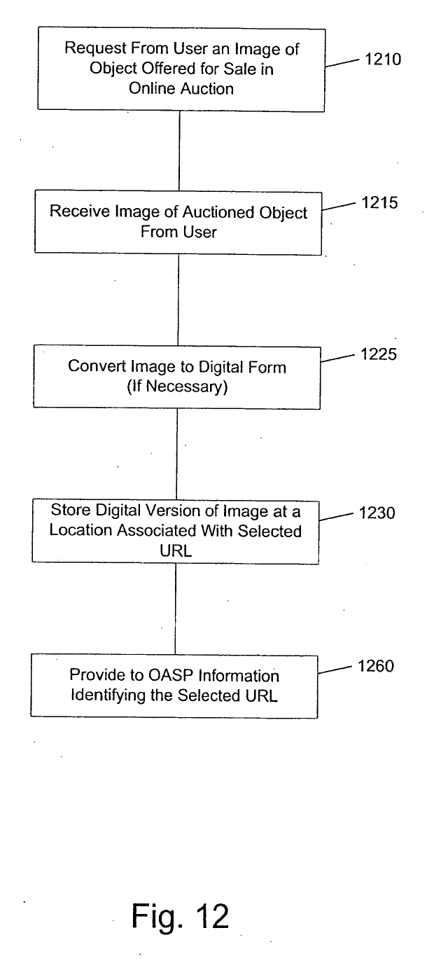

A user may also provide to the information assistance service provider an image (such as a photograph) of an object that the user offers for sale in an online auction. This capability is particularly useful when the OASP selected by the user provides sellers the option of posting a link to a photograph (or other image) of an offered item. FIG. 12 is a flowchart depicting an example of a routine for making an image of an item available for viewing by prospective bidders, in accordance with an embodiment of the invention. The steps outlined in FIG. 12 may be performed in conjunction with the routine described in FIG. 10. At step 1210, the operator requests from the user an image of the object offered for sale in the auction. Referring to the example described above, when the information assistance service assists Mr. Smith in initiating an auction to sell his collection of Elvis Presley albums, as described above, the operator may additionally ask Mr. Smith if he wishes to provide photograph(s) of some or all of the albums. Supposing that Mr. Smith replies that yes, he would like to do so, the operator suggests that he send the photograph(s) either by mail, by facsimile, or in electronic form via email. In this example Mr. Smith chooses to send a single photograph by mail to the information assistance service. It should be noted that the image may be received from the user in any one of a variety of ways. The user may send a photograph by mail or by fax, for example. Alternatively, the user may send a digital version of the image by email.

At step 1215, an image of the object to be offered in the auction—in this example, Mr. Smith's photograph—is received from the user. At step 1225, the information assistance service converts the image to digital form, if necessary. Techniques for generating a digital version of a photograph or other similar image are well-known. At step 1230, the information assistance service stores the digital version of the image in storage at a location associated with a selected URL. The information assistance service also provides to the respective OASP information identifying the selected URL (step 1260). The OASP may subsequently indicate to prospective bidders that an image of the item may be viewed by visiting the specified URL.

Finally, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

What is claimed is:

1. A method performed by a communications system, the method comprising:
receiving via a wireless communications device a request to initiate an auction with an online auction service unaffiliated with the communications system; and
initiating the auction with the online auction service, based on the request.

2. The method of claim 1, wherein the request is received from a user, the method further comprising:
receiving from the user information identifying an auction account.

3. The method of claim 2, wherein the auction account is with the online auction service.

4. The method of claim 2, further comprising:
accessing a data file associated with the user and stored by the system;
retrieving from the data file data concerning access to the auction account; and
accessing the auction account, based on the data.

5. The method of claim 4, wherein the data concerning access to the auction account comprises one or more data items selected from the following: a user name and a password.

6. The method of claim 4, wherein the data concerning access to the auction account comprises a Uniform Resource Locator (URL).

7. The method of claim 1, wherein the request is received from a user, the method further comprising:
identifying one or more items required by the online auction service for initiating the auction;
requesting from the user information pertaining to the one or more items;
receiving the information from the user; and
transmitting the information to the online auction service.

8. The method of claim 7, wherein the information includes one or more items selected from the following: a title of an auction, a minimum bid value, a duration of an auction, a description of an object to be offered for sale, a number of objects to be offered in an auction, and a minimum bid increment value.

9. The method of claim 1, further comprising:
receiving from the user at least one image of one or more objects offered in the auction; and
posting a digital version of the at least one image at a location on a network that is accessible to persons bidding in the auction.

10. The method of claim 9, wherein the at least one image comprises one or more items selected from the following: a photograph, a facsimile image, and an digital image.

11. The method of claim 9, comprising:
posting a digital version of the at least one image at a URL accessible via an Internet connection.

12. The method of claim 1, wherein the communications system comprises an information assistance provider.

13. A method performed by a communications system, the method comprising:
receiving a request to initiate an auction;
accessing an auction account maintained by a second system not affiliated with the communications system, in accordance with the request; and
initiating an auction with the second system via the auction account, based on the request.

14. The method of claim 13, wherein the request includes a telephone call.

15. The method of claim 13, comprising:
receiving the request through a first communication connection; and
accessing the auction account through a second communication connection.

16. The method of claim 15, wherein the first communications connection includes a telephonic connection.

17. The method of claim 13, further comprising verifying the user's identity before the auction is initiated.

18. The method of claim 13, wherein the request is received from a user, the method further comprising:
accessing a data file associated with the user and stored by the communications system;
retrieving from the data file data concerning access to the auction account; and
accessing the auction account over a second communications connection, based on the data.

19. The method of claim 18, wherein the data concerning access to the auction account comprises one or more data items selected from the following: a user name and a password.

20. The method of claim 18, wherein the data concerning access to the auction account comprises a Uniform Resource Locator (URL).

21. The method of claim 13, wherein the auction account comprises at least one online auction account.

22. The method of claim 13, wherein the request comprises information specifying an auction account.

23. The method of claim 13, wherein the request is received from a user, the method further comprising:
identifying one or more items required by an online auction service associated with the auction account;
receiving from the user information pertaining to the one or more items; and
transmitting the information to the online auction service.

24. The method of claim 23, wherein the information includes one or more items selected from the following: a title of an auction, a minimum bid value, a duration of an auction, a description of an object to be offered for sale, a number of objects to be offered in an auction, and a minimum bid increment value.

25. The method of claim 13, wherein the request is received from a user, the method further comprising:
receiving from the user at least one image of one or more objects offered in the auction; and
posting a digital version of the at least one image at a location on a network that is accessible to persons bidding in the auction.

26. The method of claim 25, wherein the at least one image comprises one or more items selected from the following: a photograph, a facsimile image, and an digital image.

27. The method of claim 25, comprising:
posting a digital version of the at least one image at a URL accessible via an Internet connection.

28. The method of claim 13, wherein the communications system comprises an information assistance service provider.

29. The method of claim 13, wherein the second system is an online auction service provider.

30. The method of claim 13, wherein the auction account is associated with a user of the communications system.

31. The method of claim 13, wherein the auction account is associated with the communications system.

32. A communications system, comprising:
an interface configured to:
receive via a wireless communications device a request to initiate an auction with an online auction service unaffiliated with the communications system; and
a processor configured to:
initiate the auction with the online auction service, based on the request.

33. The system of claim 32, wherein the request is received from a user, the interface being further configured to:
receive from the user information identifying an auction account.

34. The system of claim 33, further comprising:
a memory; and
wherein the processor is further configured to:
access a data file associated with the user and stored in the memory;
retrieve from the data file data concerning access to the auction account; and
access the auction account, based on the data.

35. The system of claim 34, wherein the data concerning access to the auction account comprises one or more data items selected from the following: a user name and a password.

36. The system of claim 34, wherein the data concerning access to the auction account comprises a Uniform Resource Locator (URL).

37. The system of claim 32, wherein the request is received from a user, the processor being further configured to:
identify one or more items required by the online auction service for initiating the auction;
request from the user information pertaining to the one or more items;
receive the information from the user; and
transmit the information to the online auction service.

38. The system of claim 37, wherein the information includes one or more items selected from the following: a title of an auction, a minimum bid value, a duration of an auction, a description of an object to be offered for sale, a number of objects to be offered in an auction, and a minimum bid increment value.

39. The system of claim 32, wherein the request is received from a user, the interface being further configured to:
receive from the user at least one image of one or more objects offered in the auction; and
wherein the processor is further configured to:
post a digital version of the image at a location on a network that is accessible to persons bidding in the auction.

40. The system of claim 39, wherein the at least one image comprises one or more items selected from the following: a photograph, a facsimile image, and an digital image.

41. The system of claim 39, wherein the processor is further configured to:
post a digital version of the at least one image at a URL accessible via an Internet connection.

42. The system of claim 32, wherein the communications system comprises an information assistance provider.
